(19) United States
(12) Patent Application Publication
(10) Pub. No.: US 2025/0067851 A1
(43) Pub. Date: Feb. 27, 2025

(54) LIDAR SYSTEM AND VEHICLE SYSTEM

(71) Applicant: TUDATONG (SUZHOU) CO., LTD., SUZHOU (CN)

(72) Inventors: Heng Sun, SUZHOU (CN); Xiongfei Zhai, SUZHOU (CN); Lirui Lu, SUZHOU (CN)

(73) Assignee: TUDATONG (SUZHOU) CO., LTD., SUZHOU (CN)

(21) Appl. No.: 18/814,395

(22) Filed: Aug. 23, 2024

(30) Foreign Application Priority Data
Aug. 24, 2023 (CN) 202311071001.0

(51) Int. Cl. G01S 7/481; G01S 17/931

(52) U.S. Cl. CPC G01S 7/4817; G01S 17/931

(57) ABSTRACT

The present disclosure provides a LiDAR system and a vehicle system. The LiDAR system includes an emitting module, a scanning module and a receiving module. The emitting module is configured to emit probe light, the probe light is reflected by a target to be measured to form echo light. The receiving module is configured to receive the echo light. The scanning module includes a rotating mirror and a galvanometer, both the rotating mirror and the galvanometer are configured to direct the probe light and the echo light, the rotating mirror is configured for scanning in a first direction of the LiDAR system, the galvanometer is configured for scanning in a second direction of the LiDAR system different from the first direction, and the galvanometer and the rotating mirror are at least partially located in a same plane to reduce space occupied by the galvanometer and the rotating mirror, thereby reducing space occupied by the LiDAR system, so that both a structural size and performance are taken into account for the LiDAR system.

### FIELD OF TECHNOLOGY

The present disclosure relates to the field of LiDAR, and more specifically to a LiDAR system and a vehicle system.

### BACKGROUND

In autonomous driving and intelligent transportation technologies, LiDAR is becoming an indispensable and important technical component. Taking autonomous vehicles as an example, LiDAR is generally used to detect the surrounding environment of the vehicles, in order to obtain information on the road, the attitude of surrounding vehicles, and other obstacles for guiding and controlling the vehicles' steering and speed.

The setting of a LiDAR system directly affects the structural size of LiDAR. However, it is difficult for existing LiDAR to take into account both the structural size and performance.

### SUMMARY

Embodiments of the present disclosure provide a LiDAR system and a vehicle system, which reduce the space occupied by the LiDAR system and take into account both the structural size and performance of the LiDAR system.

According to one aspect of the present disclosure, a LiDAR system is provided, including: an emitting module configured to emit probe light, where the probe light is reflected by a target to be measured to form echo light; a scanning module including a rotating mirror and a galvanometer, where both the rotating mirror and the galvanometer are configured to direct the probe light and the echo light, the rotating mirror is configured for scanning in a first direction of the LiDAR system, the galvanometer is configured for scanning in a second direction of the LiDAR system different from the first direction, and the galvanometer and the rotating mirror are at least partially located in a same plane; and a receiving module configured to receive the echo light.

According to one aspect of the present disclosure, a vehicle system is provided, including the LiDAR system of the aforementioned aspect.

In the LiDAR system provided according to the embodiment of the present disclosure, the rotating mirror scans in a first direction of the LiDAR system, the galvanometer scans in a second direction of the LiDAR system different from the first direction, achieving the detection effect of the LiDAR system, and the galvanometer and the rotating mirror are at least partially located in the same plane to reduce the space occupied by the galvanometer and the rotating mirror, thereby reducing the space occupied by the LiDAR system, so that both the structural size and performance are taken into account for the LiDAR system.

It should be understood that the content described in this section is not intended to identify key or important features of embodiments of the present disclosure, nor is it intended to limit the scope of the present disclosure. Other features of the present disclosure will be easily understood through the following specification.

### BRIEF DESCRIPTION OF THE DRAWINGS

The drawings exemplarily illustrate embodiments and constitute part of the specification, and together with the textual description of the specification, serve to illustrate exemplary implementations of the embodiments. The embodiments shown are for illustrative purposes only and do not limit the scope of claims. In all the drawings, the same reference numerals refer to the same elements or similar but not necessarily identical elements.

FIG. 1 is a schematic system block diagram illustrating a LiDAR system according to an embodiment of the present disclosure;

FIGS. 2(a) and 2(b) are schematic structural diagrams illustrating a first LiDAR system according to an embodiment of the present disclosure;

FIG. 3 is a schematic structural diagram illustrating a second LiDAR system according to an embodiment of the present disclosure;

FIG. 4 is a schematic structural diagram illustrating a third LiDAR system according to some other embodiments of the present disclosure;

FIG. 5 is a schematic structural diagram illustrating a reflecting mirror according to some other embodiments of the present disclosure;

FIG. 6 is a schematic structural diagram illustrating arrangement of a first emitting module and a receiving module according to some other embodiments of the present disclosure;

FIG. 7 is a schematic structural diagram illustrating arrangement of a second emitting module and a receiving module according to some other embodiments of the present disclosure;

FIG. 8 is a schematic structural diagram illustrating arrangement of a second emitting module and a receiving module according to an embodiment of the present disclosure;

FIG. 9 is a schematic structural diagram illustrating a vehicle system according to an embodiment of the present disclosure; and

FIG. 10 illustrates a point cloud image obtained by a first LiDAR system according to an embodiment of the present disclosure.

### DESCRIPTION OF REFERENCE NUMERALS

1000. LiDAR system; 2000. vehicle;
100. emitting module; 110. light source; 120. emitting lens assembly;
200. scanning module; 210. rotating mirror; 220. galvanometer;
300. receiving module; 310. detector; 320. receiving lens assembly; 321. hole or slot;
400. reflecting mirror; 410. reflecting region; 420, transmission region; and
500. target to be measured.

### DESCRIPTION OF THE EMBODIMENTS

Further detailed description of the present disclosure will be provided below in conjunction with the drawings and embodiments. It can be understood that the specific embodiments described herein are merely to illustrate the related invention, and are not intended to limit the invention. Additionally, it should be noted that for ease of description, only parts related to the related invention are shown in the drawings.

It should be noted that the embodiments of the present disclosure and the features in the embodiments may be combined with each other unless without conflict. Unless otherwise explicitly stated in the context, if the number of elements is not specifically limited,
the element can be one or plural. In addition, the numbers of steps or functional modules used in the present disclosure are only used to identify each step or functional module, and are not used to limit the execution order of each step or the connection relationship between each functional module.

In the present disclosure, unless otherwise specified, the use of the terms “first”, “second”, etc. to describe various elements is not intended to define the positional relationship, temporal relationship, or importance relationship of these elements, and such terms are simply used to distinguish one element from another element. In some examples, the first element and the second element may refer to the same instance of the element, while in some cases, they may also refer to different instances based on contextual descriptions.

In the present disclosure, the terms used in the description of various described examples are for the purpose of describing specific examples only, and are not intended to be limiting. Unless otherwise explicitly stated in the context, if the number of elements is not specifically limited, the element can be one or plural. In addition, the term “and/or” used in the present disclosure encompasses any one and all possible combinations of the listed items.

“LiDAR system” refers to a light detection and ranging system that utilizes light to detect a target position and obtain feature quantities such as a target distance, a target speed and a target attitude. Generally, a LiDAR system may include an emitting module, a scanning module and a receiving module. The emitting module is configured to emit probe light. The scanning module is configured to direct the probe light emitted by LiDAR in a specific direction, and the scanning module may direct the emitted probe light along different paths to enable the LiDAR system to scan the surrounding environment. The probe light emitted by the LiDAR system is reflected or scattered after reaching surrounding objects. The probe light is reflected by a target to be measured to form echo light, which is returned to the LiDAR. The scanning module may also be configured to redirect the returned echo light to the receiving module. The receiving module is configured to receive the echo light. The LiDAR system may determine the distance to the object along the path of the emitted probe light using the time taken to detect the returned echo light after emitting the probe light and the speed of light. As is readily understood by those skilled in the art, the LiDAR system may also utilize other techniques to measure the surrounding environment.

The “scanning module” refers to a system that changes the direction of an optical signal. The scanning module may include one or more optical redirecting elements (e.g., a rotating mirror and a galvanometer) to steer the probe light along the emitting path to scan the external surroundings, for example, by rotation, vibration or guidance. The scanning module may also steer the returned echo light along the receiving path to direct the returned echo light to the receiving module. The optical redirecting elements that direct the probe light and the echo light along the emitting and receiving paths may be the same component (e.g., a shared component), a discrete component (e.g., a dedicated component), and/or a combination of shared and discrete components. These optical redirecting elements may include, for example, a galvanometer, a rotating mirror (such as a rotating polyhedral mirror), or a fixed mirror to steer the emitted probe light or the received echo light to different directions.

The “rotating mirror” refers to an optical element that steers the probe light or the echo light by the rotational motion of the mirror. In some examples, the rotating mirror is configured to be capable of rotating clockwise or counterclockwise at least one rotation, for example, to achieve scanning of one or more signals in a horizontal direction of the LiDAR system.

In some embodiments, the “rotating mirror” may refer to a polyhedral mirror that is capable of rotation.

The “galvanometer” refers to an optical element that steers the probe light or the echo light by the vibrational motion of the mirror. In some examples, the galvanometer is configured to be capable of pitching motion by a predetermined angle, for example, to achieve scanning of one or more signals in a vertical direction of the LiDAR system.

The arrangement method between the emitting module, the scanning module, and the receiving module of the LiDAR system directly determines the overall structural size of the LiDAR system. However, it is difficult for existing LiDAR systems to achieve a balance between volume and performance, and it is difficult to meet the market trend of a small structural size and excellent performance. For example, LiDAR systems with smaller structural sizes have detection performance that cannot meet the requirements, while those that meet the requirements need to take up larger space. Therefore, how to improve space utilization, have a compact structure, and take into account performance at the same time is of extreme importance.

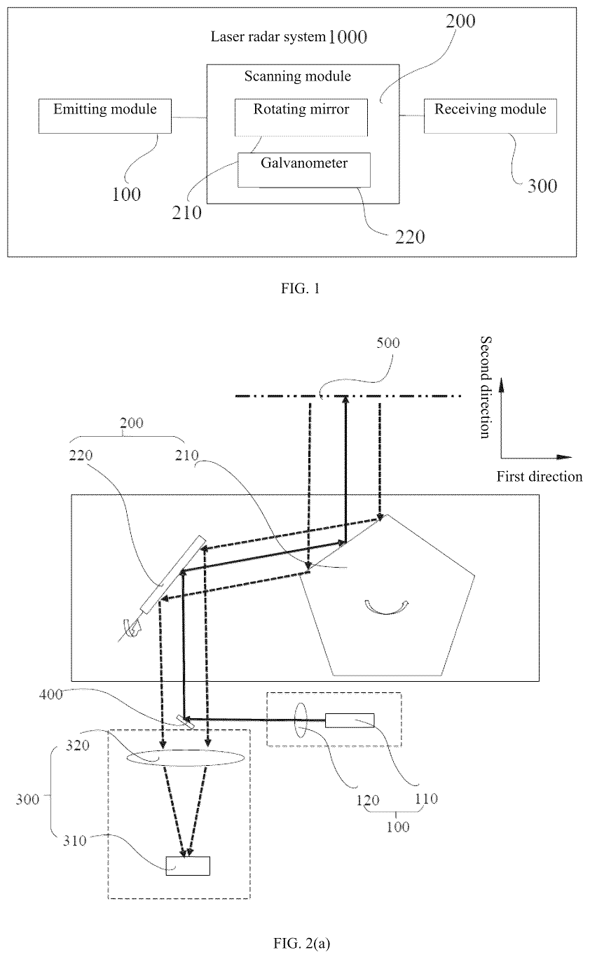

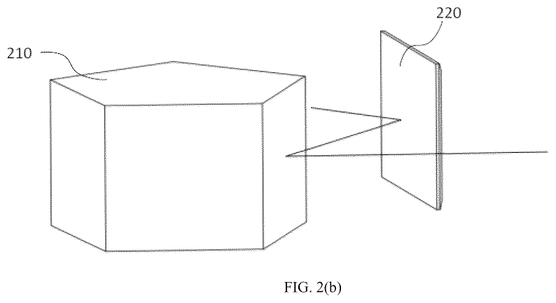

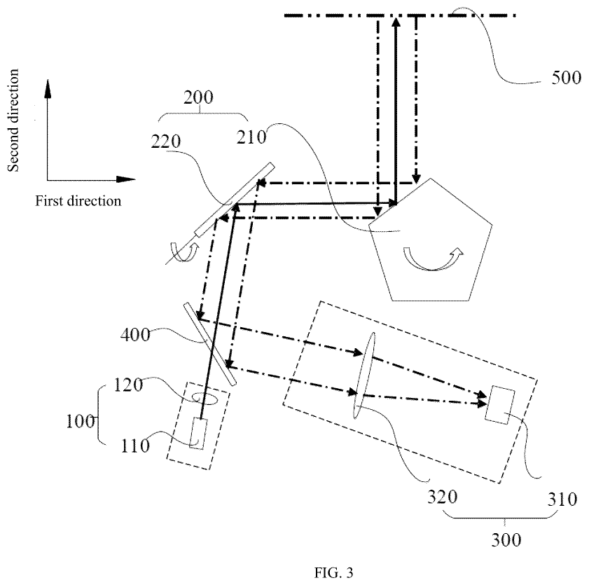

FIG. 1 shows a schematic system block diagram of a LiDAR system 1000 according to an embodiment of the present disclosure, FIG. 2(a) shows a schematic structural diagram of a first LiDAR system 1000 according to an embodiment of the present disclosure, and FIG. 3 shows a schematic structural diagram of a second LiDAR system 1000 according to an embodiment of the present disclosure, where the probe light and the echo light pass through a reflecting mirror 400. In view of this, an embodiment of the present disclosure proposes a LiDAR system 1000, as shown in FIGS. 1-3. Since the galvanometer 220 and the rotating mirror 210 of the scanning module 200 are at least partially located in a same plane, the space occupied by the scanning module 200 is reduced, and the space utilization of the LiDAR system 1000 is improved. By scanning of the rotating mirror 210 in the first direction of the LiDAR system and scanning of the galvanometer 220 in the second direction of the LiDAR system, the LiDAR system takes into account both space utilization and performance.

In the LiDAR system 1000 according to the embodiment of the present disclosure, the LiDAR system 1000 includes an emitting module 100, a scanning module 200 and a receiving module 300. The emitting module 100 is configured to transmit probe light, and the probe light is reflected by a target to be measured 500 to form echo light. The scanning module 200 includes a rotating mirror 210 and a galvanometer 220, both the rotating mirror 210 and the galvanometer 220 are configured to direct the probe light and the echo light, the rotating mirror 210 is configured for scanning in a first direction of the LiDAR system 1000, and the galvanometer 220 is configured for scanning in a second direction of the LiDAR system 1000 different from the first direction. For example, the rotating mirror 210 is configured for scanning in a horizontal direction of the LiDAR system 1000, and the galvanometer 220 is configured for scanning in a vertical direction of the LiDAR system 1000. The galvanometer 220 and the rotating mirror 210 are at least partially located in the same plane. The receiving module 300 is configured to receive the echo light.

It should be noted that in existing LiDAR systems, the galvanometer and the rotating mirror are generally misaligned at an interval in the vertical direction to meet the scanning range requirements. However, in the embodiment of the present disclosure, since the galvanometer 220 and the rotating mirror 210 are at least partially located in the same plane, the galvanometer 220 and the rotating mirror 210 at least partially overlap in the vertical direction, and the size in the vertical direction is reduced, thereby reducing the space occupied by the scanning module 200. It should be understood that the first direction may be a horizontal direction and the second direction may be a vertical direction, but the first direction and the second direction should not be limited to the horizontal direction and the vertical direction described above.

In some cases, the first direction may also be a direction having a certain inclination angle with respect to the horizontal direction, the first direction is approximately the same as the horizontal direction, and the second direction and the first direction are directions perpendicular in a plane.

In some embodiments, the galvanometer 220 and the rotating mirror 210 may be configured in the same plane, such that the galvanometer 220 and the rotating mirror 210 completely overlap in the vertical direction.

Since the LiDAR system 1000 is often mounted on other devices, for example, the LiDAR system 1000 is often mounted in certain narrow space of a vehicle 2000, and the vehicle 2000 has a certain limitation on the mounting space of the LiDAR system 1000. Therefore, it can be seen that the galvanometer 220 and the rotating mirror 210 of the embodiment of the present disclosure are at least partially located in the same plane, and it appears extremely important to reduce the space occupied by the scanning module 200.

FIG. 2(b) illustrates a side view of the scanning module 200 of the LiDAR system 1000 in the embodiment shown in FIG. 2(a), where the galvanometer 220 and the rotating mirror 210 at least partially overlap in the vertical direction. This arrangement of the galvanometer and the rotating mirror may reduce the size of the scanning module 200 in the vertical direction, thereby reducing the space occupied by the LiDAR system 1000 on the vehicle.

In some embodiments, the rotating mirror 210 and the galvanometer 220 are arranged such that a horizontal field of view formed by the probe light is greater than 120°.

Specifically, the rotating mirror 210 and the galvanometer 220 rotate so that the horizontal field of view is formed when the probe light is emitted to the target to be measured 500. For example, the rotating mirror 210 is configured to be capable of rotating clockwise or counterclockwise at least one rotation, and the probe light scans in the horizontal direction of the LiDAR system 1000 after passing through the rotating mirror 210 and the galvanometer 220, forming the horizontal field of view greater than 120°, so that the horizontal field of view formed by scanning meets the detection requirements.

In some embodiments, the number of reflecting surfaces of the rotating mirror may be 5 as shown in FIGS. 2 to 4, or any number of surfaces that are capable of achieving signal scanning in the horizontal direction. Those skilled in the art should be aware that the discussion on the number of reflecting surfaces of the rotating mirror in the present disclosure should not constitute a limitation on the scope of protection of the present disclosure.

In some embodiments, the rotating mirror 210 and the galvanometer 220 are arranged such that the vertical field of view formed by the probe light is greater than 25°.

Specifically, the rotating mirror 210 and the galvanometer 220 rotate so that the vertical field of view is formed when the probe light is emitted to the target to be measured 500. For example, the galvanometer 220 is configured to be capable of pitching motion by a predetermined angle, and the probe light passes through the rotating mirror 210 and the galvanometer 220, and scans in the vertical direction of the LiDAR system 1000, forming the vertical field of view greater than 25°, so that the vertical field of view formed by scanning meets the detection requirements.

Since the rotating mirror 210 and the galvanometer 220 are arranged such that the horizontal field of view formed by the probe light is greater than 120° and the vertical field of view formed by the probe light is greater than 25°, the detection range of the LiDAR system 1000 meets the requirements, and since the galvanometer 220 and the rotating mirror 210 of the scanning module 200 are at least partially located in the same plane, the space occupied by the scanning module 200 is reduced, and the space utilization of the LiDAR system 1000 is improved, so that both the space utilization and performance are taken into account for the LiDAR system 1000.

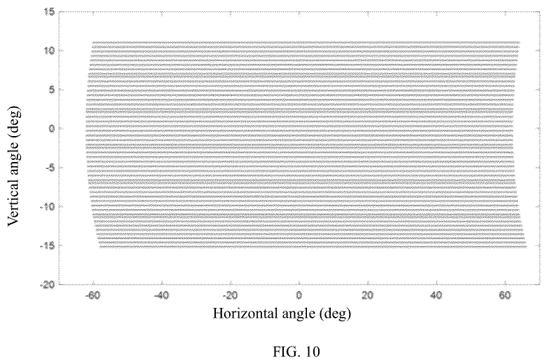

FIG. 10 illustrates a point cloud image obtained by the LiDAR system 1000 when the rotating mirror 210 and the galvanometer 220 are arranged such that the vertical field of view formed by the probe light is greater than 25°. Through the above arrangement of the galvanometer and the rotating mirror, in addition to increasing the range of the scanning field of view, a regular point cloud shape can also be obtained, which may improve the computational efficiency of the system and save computing resources to a certain extent.

In an embodiment, as shown in FIGS. 2(a) and 3, the emitting module 100 is disposed axially at an angle to the receiving module 300, for example, the emitting module 100 is disposed obliquely at a preset included angle to the receiving module 300. In an embodiment, the emitting module 100 is disposed at a right angle to the receiving module 300. It should be noted that the emitting module 100 is disposed obliquely at a preset included angle to the receiving module 300, which means that the probe light emitted by the emitting module 100 is at a preset included angle to the echo light received by the receiving module 300, and an optical path of the probe light before collimation and convergence is at a preset angle to an optical path of the echo light.

It should be noted that the emitting module 100 is disposed axially at an angle to the receiving module 300, so that the arrangement of the emitting module 100 and the receiving module 300 is convenient, and it is convenient to flexibly dispose the emitting module 100 and the receiving module 300 in the case of limited space.

In an embodiment, as shown in FIG. 2(a), the LiDAR system 1000 further includes a reflecting mirror 400. The probe light of the emitting module 100 is directed to the galvanometer 220 and the rotating mirror 210 through the reflecting mirror 400, and the echo light is directed to the receiving module 300 through the rotating mirror 210 and the galvanometer 220 in sequence.

Specifically, the reflecting mirror 400 is located in the optical path of the probe light and the echo light. For example, the emitting module 100 is disposed axially at an angle to the receiving module 300, the probe light emitted by the emitting module 100 is reflected by the reflecting mirror 400 and then projected onto the galvanometer 220, and the echo light is directed to the receiving module 300 through the rotating mirror 210 and the galvanometer 220 in sequence. It should be noted that the echo light after passing through the galvanometer 220 passes through a region where the reflecting mirror 400 is located. Due to a relatively small structural size of the reflecting mirror 400, the amount of light projected onto the reflecting mirror 400 is relatively small, and a great amount of the echo light is converged to the receiving module 300. At this time, the proportion of echo light reflected by the reflecting mirror 400 is relatively small and will not affect the detection (scanning) effect of the target to be measured 500. By disposing the reflecting mirror 400, it is beneficial to realize that the emitting module 100 is disposed axially at an angle to the receiving module 300, improving the flexibility of arrangement.

In an embodiment, as shown in FIG. 3, the LiDAR system 1000 further includes a reflecting mirror 400. The probe light of the emitting module 100 is directed to the galvanometer 220 and the rotating mirror 210 through the reflecting mirror 400, and the echo light is directed to the receiving module 300 through the rotating mirror 210, the galvanometer 220 and the reflecting mirror 400 in sequence.

Specifically, the structural size of the reflecting mirror 400 are relatively large, the reflecting mirror 400 is located in the reflecting mirror 400 is in the optical path of the probe light and the optical path of the echo light, and the reflecting mirror 400 can realize the reflection and transmission of light. For example, a partial region of the reflecting mirror 400 is transparent, and the transparent region can allow light to be transmitted. The probe light from the emitting module 100 reaches the reflecting mirror 400 and is then projected from the reflecting mirror 400 to the galvanometer 220 and the rotating mirror 210, and the probe light is not reflected at the reflecting mirror 400. When the echo light is directed to the reflecting mirror 400 through the rotating mirror 210 and the galvanometer 220, the echo light is reflected by the reflecting mirror 400, and the path of the echo light is changed until the echo light is directed to the receiving module 300.

It should be noted that the above FIG. 3 is only an example form of the LiDAR system 1000 according to the embodiment of the present disclosure, and does not limit the protection range of the LiDAR system 1000 according to the embodiment of the present disclosure.

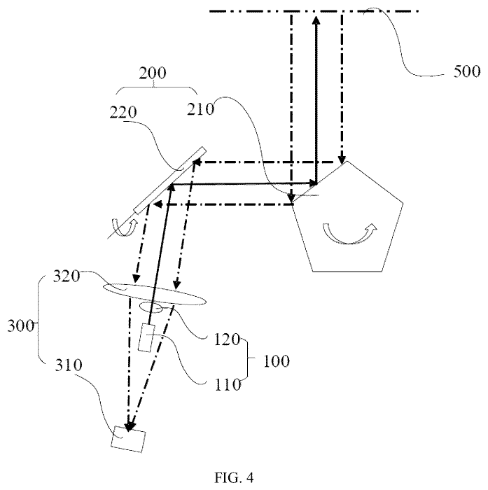

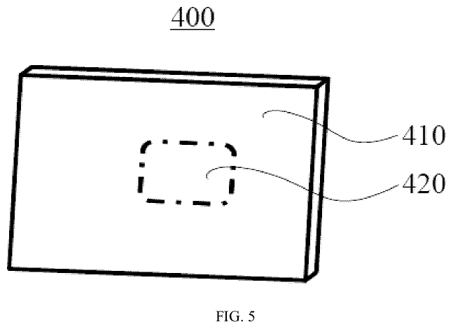

FIG. 4 is a schematic structural diagram illustrating a third LiDAR system 1000 according to some other embodiments of the present disclosure, where the emitting module 100 is disposed axially coinciding with the receiving module 300. As shown in FIG. 4, in some embodiments, the emitting module 100 is disposed axially coinciding with the receiving module 300. The emitting module 100 and the receiving module 300 emit or converge light through different lenses. For example, a light source 110 of the emitting module 100 is located at the focal point of a lens, and the lens transmits the probe light emitted by the light source 110 to the other side to form a parallel detection beam. A detector 310 of the receiving module 300 is located at the focal point of another lens, and another lens transmits the echo light and converges it to the detector 310. At this time, the echo light is parallel before passing through another lens. Since the emitting module 100 is disposed axially coinciding with the receiving module 300, the parallel echo light is parallel to the optical path of the probe light, reducing the arrangement space of the emitting module 100 and the receiving module 300, thereby further reducing the space size occupied by the LiDAR system 1000.

FIG. 5 is a schematic structural diagram illustrating a reflecting mirror according to some other embodiments of the present disclosure. As shown in FIG. 5, in an embodiment, the reflecting mirror 400 is provided with a reflecting region 410 and a transmission region 420. The reflecting region 410 is configured to reflect the echo light to the receiving module 300, and the transmission region 420 is configured to transmit the probe light of the emitting module 100.

Specifically, the reflecting mirror 400 is block-shaped, and the block-shaped reflecting mirror 400 is provided with a reflecting region 410 and a transmission region 420. The probe light emitted by the emitting module 100 is transmitted through the transmission region 420 of the reflecting mirror 400, passes through the galvanometer 220 and the rotating mirror 210, and is then directed to the target to be measured 500. The probe light is reflected by the target to be measured 500 to form the echo light, the echo light is directed to the reflecting mirror 400 after passing through the rotating mirror 210 and the galvanometer 220, and the echo light is reflected from the reflecting region 410 of the reflecting mirror 400 to the receiving module 300, thereby completing the scanning detection of the target to be measured 500. For example, the reflecting mirror 400 is rectangular, with half of the region passing through the center of the rectangle being the reflecting region 410 and the other half being the transmission region 420. The reflecting region 410 reflects the echo light to the receiving module 300, and the probe light of the emitting module 100 is transmitted through the transmission region 420.

Since the reflecting mirror 400 is provided with the reflecting region 410 and the transmission region 420, the reflecting region 410 is configured to reflect the echo light to the receiving module 300, and the transmission region 420 is configured to transmit the probe light of the emitting module 100, the echo light and the probe light can be concentrated, thereby further facilitating the arrangement of the emitting module 100 and the receiving module 300, so that the arrangement of the emitting module 100 and the receiving module 300 is more flexible in the case of limited space.

In some embodiments, the reflecting region 410 is disposed surrounding the transmission region 420, and the transmission region 420 is disposed correspondingly to the emitting module 100. Specifically, the transmission region 420 is located in the middle position of the reflecting mirror 400, the reflecting region 410 is disposed surrounding the transmission region 420
(see FIG. 5), the transmission region 420 is disposed correspondingly to the emitting module 100. The probe light emitted by the emitting module 100 passes through the transmission region 420 and is directed to the galvanometer 220, and the echo light is reflected from the reflecting region 410 to the receiving module 300.

It should be noted that the area of the transmission region 420 is smaller compared with that of the reflecting region 410, the vast majority of the echo light is reflected from the reflecting region 410 to the receiving module 300, and a very small portion of the echo light is transmitted through the transmission region 420. Therefore, the arrangement method of the reflecting region 410 being disposed surrounding the transmission region 420 does not affect the detection effect of the LiDAR system 1000, and at the same time, also facilitates the flexible arrangement of the receiving module 300 and the emitting module 100.

Since the reflecting region 410 is disposed surrounding the transmission region 420, and the transmission region 420 is disposed correspondingly to the emitting module 100, the probe light loss of the emitting module 100 is reduced, thereby improving the detection effect of the LiDAR system 1000. At the same time, it facilitates the flexible arrangement of the receiving module 300 and the emitting module 100, which is conducive to reducing the space occupied by the LiDAR system 1000.

In an embodiment, the transmission region 420 is a through hole. For example, the reflecting mirror 400 is a block-shaped single-sided mirror, and a through hole is provided at the middle position of the block-shaped single-sided mirror to form the transmission region 420. The through hole is disposed correspondingly to the emitting module 100. The probe light emitted by the emitting module 100 passes through the through hole, and the echo light is directed from the reflecting region 410 on the peripheral side of the through hole on the reflecting mirror 400 to the receiving module 300. By disposing the transmission region 420 as a through hole, the probe light has no transmission loss, and at the same time, the processing process of the transmission region 420 is reduced, and the cost of the reflecting mirror 400 is reduced.

In an embodiment, the reflecting mirror 400 is provided with a partition coating, and the partition coating forms the transmission region 420 and the reflecting region 410.

Specifically, separate coating is performed on different regions of the reflecting mirror 400 by utilizing a coating process, a transmission film is coated in the preset transmission region 420, and a reflecting film is coated in the region of the reflecting region 410, which may reduce the area of the transmission region, increase the proportion of the reflecting region, and reduce the reflection loss of the echo light.

For example, a thin film is coated on the substrate of the reflecting mirror 400 by utilizing vacuum sputtering, the reflectivity and transmittance of the incident light beam of the reflecting mirror 400 are controlled to meet the requirements of emission and transmission. An anti-reflection film is coated on the transmission region 420 of the reflecting mirror 400, and a high reflection film is coated on the reflecting region 410 of the reflecting mirror 400. By performing partition coating on the reflecting mirror 400, the transmission region 420 and the reflecting region 410 are formed, so that the probe light and the echo light pass through different regions, achieving the detection and scanning of the LiDAR system 1000.

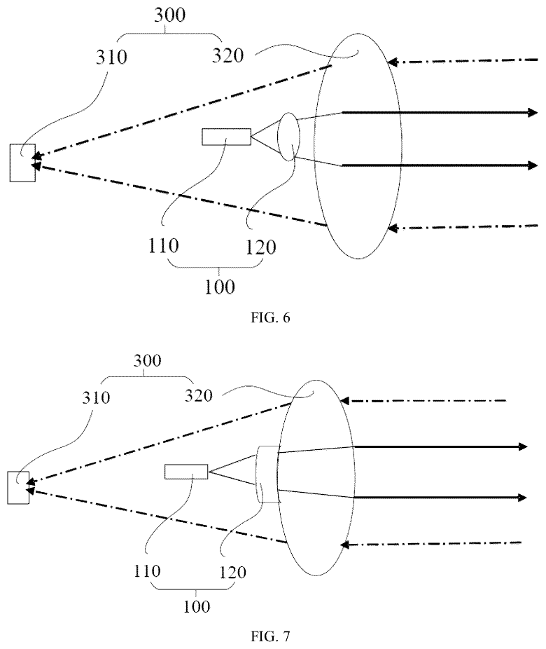

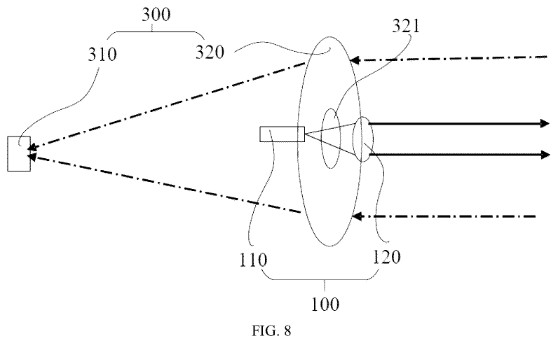

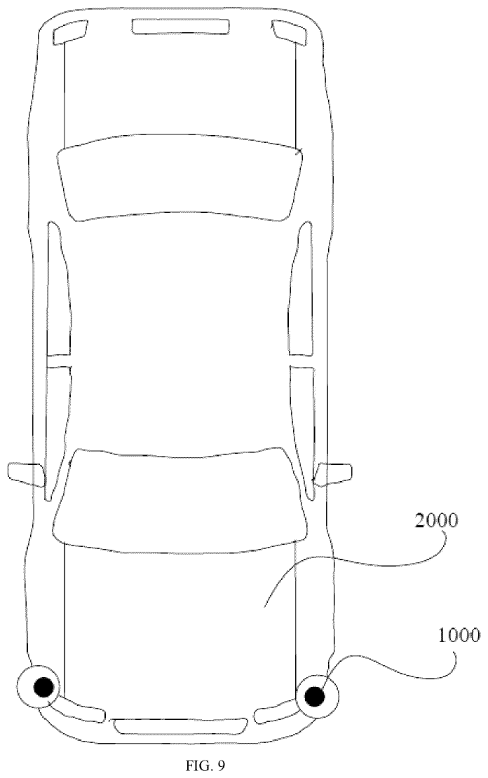

FIG. 6 is a schematic structural diagram illustrating arrangement of a first emitting module 100 and the receiving module 300 according to some other embodiments of the present disclosure, where a receiving lens assembly 320 is disposed axially coinciding with an emitting lens assembly 120. FIG. 7 is a schematic structural diagram illustrating arrangement of a second emitting module 100 and the receiving module 300 according to some other embodiments of the present disclosure, where the receiving lens assembly 320 is bonded to the emitting lens assembly 120. FIG. 8 is a schematic structural diagram illustrating arrangement of a third emitting module 100 and the receiving module 300 according to some other embodiments of the present disclosure, where the receiving lens assembly 320 is provided with a hole or slot 321.

As shown in FIGS. 6-7, in an embodiment, the emitting module 100 is provided with the emitting lens assembly 120, and the receiving module 300 is provided with the receiving lens assembly 320. The echo light passes through the receiving lens assembly 320 to converge the echo light, and the receiving lens assembly 320 is disposed axially coinciding with the emitting lens assembly 120.

Specifically, the light source 110 of the emitting module 100 emits the probe light towards the receiving lens assembly 320, and the echo light is converged to the detector 310 of the receiving module 300 after passing through the receiving lens assembly 320. The receiving lens assembly 320 is disposed axially coinciding with the emitting lens assembly 120.

For example, both the emitting lens assembly 120 and the receiving lens assembly 320 are convex lenses. The light source 110 of the emitting module 100 emits the probe light towards the convex lens, and the probe light is directed to the target to be measured 500 after passing through the galvanometer 220 and the rotating mirror 210. The probe light is emitted back from the target to be measured 500 to form the echo light. The echo light passes through the rotating mirror 210, the galvanometer 220 and another convex lens to converge the echo light to the detector 310 of the receiving module 300, where the two convex lenses are disposed axially coinciding with each other. The receiving lens assembly 320 is disposed axially coinciding with the emitting lens assembly 120, which means that the center of the receiving lens assembly 320 coincides with the center of the emitting lens assembly 120, and both adopt the same axis.

Since the receiving lens assembly 320 is disposed axially coinciding with the emitting lens assembly 120, the space occupied by the emitting module 100 and the receiving module 300 is reduced, making the structure of the LiDAR system 1000 more compact and improving the space utilization. Especially, in situations where space is limited, the compact structure of the LiDAR system 1000 is extremely important. For example, when the LiDAR system 1000 is mounted on a vehicle, surrounding objects are scanned and detected by the LiDAR system 1000. For the vehicle, it is necessary to mount the LiDAR system 1000 in limited space. At this time, the receiving lens assembly 320 is disposed axially coinciding with the emitting lens assembly 120, which plays an important role in reducing the occupied space.

It should be noted that the emitting lens assembly 120 and the receiving lens assembly 320 may be one member, or may be mounted and fixedly formed by a plurality of members. For example, the receiving lens assembly 320 includes a convex lens and a collimating lens (not shown in the figure) configured to converge the echo light. The echo light enters the convex lens after passing through the collimating lens, and the echo light is transmitted through the convex lens and converged to the detector 310. Correspondingly, the receiving lens assembly 320 includes a convex lens and a collimating lens. The probe light emitted by the light source forms a parallel beam after passing through the convex lens and the collimating lens, reducing the divergence of the probe light directed to the galvanometer 220. The collimating lens and convex lens described above may be integrated into one. In some other cases, the emitting lens assembly 120 and the receiving lens assembly 320 may be one member (convex lens) without further collimation processing through the collimating lens.

As shown in FIG. 6, the emitting lens assembly 120 is disposed spaced apart from the receiving lens assembly 320. Specifically, the center of the receiving lens assembly 320 coincides with the center of the emitting lens assembly 120, and the emitting lens assembly 120 and the receiving lens assembly 320 whose axes coincide are disposed spaced apart to meet the detection and scanning requirements of the LiDAR system 1000. For example, the emitting lens assembly 120 and the receiving lens assembly 320 are two convex lenses of different sizes, and the two convex lenses of different sizes are disposed spaced apart.

It should be noted that the spacing distance between the emitting lens assembly 120 and the receiving lens assembly 320 is adapted to the size and curvature of the emitting lens assembly 120 and the receiving lens assembly 320. For example, if the emitting lens assembly 120 and the receiving lens assembly 320 are two different convex lenses, and the sizes of the convex lens of the emitting lens assembly 120 and the convex lens of the receiving lens assembly 320 are larger, the spacing distance between the emitting lens assembly 120 and the receiving lens assembly 320 may be appropriately increased to meet the detection and scanning requirements of the LiDAR system 1000.

In an embodiment, the emitting lens assembly 120 is located between the light source 110 of the emitting module 100 and the receiving lens assembly 320. Specifically, the probe light emitted by the light source 110 is transmitted through the emitting lens assembly 120 and the receiving lens assembly 320 to the galvanometer 220, and the echo light reflected from the target to be measured 500 is converged through the receiving lens assembly 320 to the detector 310. Especially, the detector 310, the light source 110, the emitting lens assembly 120, and the receiving lens assembly 320 are sequentially disposed spaced apart.

For example, the emitting lens assembly 120 and the receiving lens assembly 320 are two different convex lenses. The size of the convex lens of the emitting lens assembly 120 is smaller than the size of the convex lens of the receiving lens assembly 320. The emitting lens assembly 120 is located between the light source 110 of the emitting module 100 and the receiving lens assembly 320. The light source 110 of the emitting module 100 emits the probe light, and the probe light passes through the relatively small convex lens and the relatively large convex lens (receiving lens assembly 320) to form parallel light to the galvanometer 220. In this embodiment, opening a hole or a slot in the receiving lens assembly 320 may be avoided to reduce costs.

As shown in FIG. 7, in an embodiment, the emitting lens assembly 120 is fixedly connected to the receiving lens assembly 320. Specifically, the emitting lens assembly 120 abuts on the receiving lens assembly 320 and fixedly connected to the receiving lens assembly by an adhesive material. For example, the emitting lens assembly 120 and the receiving lens assembly 320 are bonded by an epoxy adhesive.

Since the emitting lens assembly 120 and the receiving lens assembly 320 are fixedly connected, the connection strength between the emitting lens assembly 120 and the receiving lens assembly 320 is improved, thereby enhancing the reliability of the LiDAR system. The emitting lens assembly 120 and the receiving lens assembly 320 abut on and are fixed to each other, reducing the spacing between the emitting lens assembly 120 and the receiving lens assembly 320, further making the structure of the LiDAR system 1000 compact and reducing the occupied space.

It should be noted that the above only takes the emitting lens assembly 120 and the receiving lens assembly 320 being bonded by an epoxy adhesive as an example for description, and does not limit the protection range of the LiDAR system 1000 according to the embodiment of the present disclosure. In some other cases, other materials may be adopted for bonding, or other methods may be adopted for fixing. For example, the emitting lens assembly 120 and the receiving lens assembly 320 are both lenses, and the two lenses are bonded with epoxy resin (see FIG. 7).

In some embodiments, the emitting lens assembly 120 may be disposed axially coinciding with or parallel to the receiving lens assembly 320. The receiving lens assembly 320 is provided with the hole or slot 321, and the hole or slot is not limited to a lens center. The center of the hole or slot may coincide with the lens center of the receiving lens assembly 320, or may deviate from the lens center of the receiving lens assembly 320. The projection of the emitting lens assembly 120 is at least partially located within the region of the hole or slot 321, so that the probe light emitted by the light source 110 may pass through the hole or slot 321 and be directed to the galvanometer 220 through the emitting lens assembly 120. The emitting lens assembly 120 may be located in front of the hole or slot 321 of the receiving lens assembly 320, or may be at least partially accommodated in the hole or slot 321 of the receiving lens assembly 320.

In some embodiments, the emitting lens assembly 120 may be disposed axially coinciding with the receiving lens assembly 320. For example, referring to FIG. 8, the hole or slot 321 is located at the center of the receiving lens assembly 320, the emitting lens assembly 120 axially coincides with the receiving lens 320, and the size of the emitting lens assembly 120 is smaller than the size of the receiving lens 320, so that the projection of the emitting lens assembly 120 is located within the region of the hole or slot 321 of the receiving lens assembly 320. In some other embodiments, the hole or slot 321 is located at the center of the receiving lens assembly 320, and the emitting lens assembly 120 axially coincides with the receiving lens assembly 320. However, the projection of the emitting lens assembly 120 is only partially located within the region of the hole or slot 321 of the receiving lens assembly 320, for example, the size of the emitting lens is slightly larger than the size of the hole or slot 321. The probe light passes through the hole or slot 321, passes through the emitting lens assembly 120, and is then directed to the galvanometer 220.

In some embodiments, the emitting lens assembly 120 is disposed axially parallel to the receiving lens assembly 320, and the axis of the emitting lens assembly 120 may deviate from the axis of the receiving lens assembly 320 by a certain distance. The hole or slot 321 in the receiving lens assembly 320 may not be disposed at the center of the receiving lens assembly 320, but may be disposed at a position that deviates by a certain distance from the center of the receiving lens assembly 320. The emitting lens assembly 120 may be fully accommodated within the hole or slot 321, or partially accommodated within the hole or slot 321, or located in front of the hole or slot 321, and the projection of the emitting lens assembly 120 falls within the region of the hole or slot 321 of the receiving lens assembly 320, so that the probe light passes through the hole or slot 321, passes through the emitting lens assembly 120, and is then directed to the galvanometer 220.

The echo light converges from the peripheral region of the hole or slot 321 on the receiving lens assembly 320 to the detector 310. For example, the receiving lens assembly 320 is a convex lens, and any position of the convex lens is provided with the hole or slot 321. For example, the hole or slot is disposed coaxially with the central axis of the convex lens, or the hole or slot is disposed parallel to the central axis of the convex lens.

An embodiment of the present disclosure further provides a vehicle system including the LiDAR system 1000 according to any one of the above.

Specifically, the LiDAR system 1000 is mounted on the vehicle system to detect a target position, obtain a target distance, a target velocity, a target attitude, etc., and determine a distance to an object along a path of the emitted probe light through the LiDAR system 1000. As is readily understood by those skilled in the art, the LiDAR system 1000 may also utilize other techniques to measure the surrounding environment.

In the vehicle system of the embodiment of the present disclosure, since the galvanometer 220 and the rotating mirror 210 of the LiDAR system 1000 are at least partially located in the same plane, the galvanometer 220 and the rotating mirror 210 at least partially overlap, reducing the size in the vertical direction, reducing the space occupied by the scanning module 200, making the structure of the LiDAR system 1000 compact, and reducing the occupied space. It should be understood that since the LiDAR system 1000 is often mounted on other devices, for example, the LiDAR system 1000 is often
mounted in narrow space of the vehicle 2000, the vehicle 2000 has a certain limitation on the mounting space of the LiDAR system 1000, and reducing the space occupied by the scanning module 200 is extremely important.

It should be noted that the vehicle system includes an automobile, a ship, an aircraft, an unmanned aerial vehicle, etc., scans and detects surrounding objects in the environment by the LiDAR system 1000, making it easy to control the motion trajectory or perform corresponding operations, such as distance display, close proximity warning, etc.

FIG. 9 is a schematic structural diagram illustrating a vehicle system according to an embodiment of the present disclosure. As shown in FIG. 9, in some embodiments, the LiDAR system 1000 is mounted on a front portion of the vehicle 2000, and detects a target in front of the vehicle 2000 through the LiDAR system 1000 located on the front portion of the vehicle 2000, and controls the operation of the vehicle based on the detection results.

For example, the LiDAR system 1000 is mounted in a headlight of the vehicle 2000, the LiDAR system 1000 is connected to a controller of the vehicle, and the controller performs corresponding control based on the detection and scanning results of the LiDAR system 1000. Especially, in an unmanned driving scenario, since the LiDAR system 1000 is mounted on a front portion of the vehicle 2000, the forward direction and the forward speed of the vehicle are controlled by the detection result of the LiDAR system 1000, timely avoiding objects ahead and reducing collision risks.

In other embodiments, the LiDAR system 1000 may also be mounted on the roof of the vehicle 2000, inside the front windshield, on the side of the car door, or at the rear of the vehicle 2000 for detecting objects in front of, on the side of, or behind the vehicle 2000.

In order to better understand the LiDAR system 1000 according to the embodiment of the present disclosure, specific details of the LiDAR system 1000 will be described below.

The present disclosure provides a LiDAR system 1000, in which the probe light of the light source 110 is incident on the galvanometer 220 and the rotating mirror 210 the target to be measured 500 is scanned in the vertical field of view and the horizontal field of view, after the target to be measured 500 returns light, the echo light is formed, and the echo light passes through the rotating mirror 210 and the galvanometer 220 and is then directed to the receiving lens assembly 320 until it enters the detector 310, achieving the detection and scanning of the target to be measured 500. Since the galvanometer 220 and the rotating mirror 210 are placed in the same plane, not only does the horizontal field of view satisfy greater than 120° horizontally and the vertical field of view satisfy greater than 25°, but also the size of the LiDAR system 1000 along the vertical direction (see FIG. 2(a)) is reduced, making the structure of the LiDAR system 1000 compact, reducing the space occupied by the LiDAR system 1000, and improving the space utilization. The LiDAR system according to the embodiment of the present disclosure is particularly suitable for mounting in space with a limited size in the vertical direction.

The emitting module 100 and the receiving module 300 adopt a non-coaxial arrangement to avoid opening a slot or a hole in the receiving lens assembly 320. Meanwhile, in the LiDAR system 1000, the reflecting mirror 400 is disposed, reflecting mirror 400 may be disposed at different angles (see FIG. 3), further making the structure of the LiDAR system 1000 compact, reducing the space occupied by the LiDAR system 1000, and improving the space utilization.

The reflecting mirror 400 may adopt a partition coating or an opening in the middle region, so that a reflecting region 410 and a transmission region 420 are formed on the reflecting mirror 400. The probe light is transmitted from the middle of the transmission region 420, and the echo light is reflected from the edge of the reflecting region 410 to the receiving module 300. It should be noted that the angle of the reflecting mirror 400 may be flexibly disposed. In different cases, the reflecting mirror 400 may be disposed to different angles (for example, the reflecting mirror 400 being at different included angles to the horizontal line), further making the structure of the LiDAR system 1000 compact and improving the space utilization.

The light source 110 passes through the emitting lens assembly 120 to collimate the probe light, and the probe light is directed through the galvanometer 220 and the rotating mirror 210 (polyhedral rotating mirror). The probe light is directed to the target to be measured 500, and reflected by the target to be measured 500 to form the echo light. The echo light is directed to the receiving module 300 to achieve scanning of the vertical field of view and the horizontal field of view. The emitting module 100 and the receiving module 300 are disposed in a manner where their axes coincide or are parallel. For example, the axes of the emitting lens assembly 120 and the receiving lens assembly 320 coincide or are parallel, making the structure of the emitting module 100 and the receiving module 300 more compact.

It should be understood that the arrangement of the coincident axes of the emitting lens assembly 120 and the receiving lens assembly 320 is achieved in at least three specific ways as below: (1) the emitting lens assembly 120 and the receiving lens assembly 320 are placed at intervals in front and behind, the probe light is collimated by the emitting lens assembly 120 and then transmitted to the galvanometer 220, and the echo light is focused by the receiving lens assembly 320 to the detector 310. (2) The emitting lens assembly 120 and the receiving lens assembly 320 are bonded together to form an integrated structure, the probe light is collimated by the emitting lens assembly 120 and then transmitted to the galvanometer 220, and the echo light is focused only by the receiving lens assembly 320 to the detector 310. (3) The hole or slot 321 is disposed at the center or a certain distance from the center of the receiving lens assembly 320, the emitting lens assembly 120 is disposed axially coinciding with the hole or slot 321, and the projection of the emitting lens assembly 120 is at least partially located within the region of the hole or slot 321.

The arrangement of the parallel axes of the emitting lens assembly 120 and the receiving lens assembly 320 is achieved in at least one specific way as below: (1) the hole or slot 321 is disposed at the center of the receiving lens assembly 320 or at a certain distance from the center of the receiving lens assembly 320, the emitting lens assembly 120 is disposed axially parallel to the hole or slot 321, and the projection of the emitting lens assembly is at least partially located within the region of the hole or slot 321.

The above description is merely an explanation of preferred embodiments of the present disclosure and the technical principles applied. Those skilled in the art should understand that the scope of the invention involved in the embodiments of the present disclosure is not limited to technical solutions formed by specific combinations of the above technical features, and should also cover other technical solutions formed by any combination of the above technical features or their equivalent features without departing from the above inventive concept, for example, technical solutions formed by mutually replacing the above features with (but not limited to) technical features with similar functions disclosed in the embodiments of the present disclosure.

The following describes some exemplary solutions of the present disclosure.

Solution 1. A LIDAR system, including:
an emitting module configured to emit probe light, where the probe light is reflected by a target to be measured to form echo light;
a scanning module including a rotating mirror and a galvanometer, where both the rotating mirror and the galvanometer are configured to direct the probe light and the echo light, the rotating mirror is configured for scanning in a first direction of the LiDAR system, the galvanometer is configured for scanning in a second direction of the LiDAR system different from the first direction, and the galvanometer and the rotating mirror are at least partially located in a same plane; and
a receiving module configured to receive the echo light.

Solution 2. The LiDAR system according to solution 1, where the rotating mirror and the galvanometer are arranged such that a horizontal field of view formed by the probe light is greater than 120°; and/or a vertical field of view formed by the probe light is greater than 25°.

Solution 3. The LiDAR system according to solution 1 or 2, where the emitting module is disposed axially coinciding with or parallel to the receiving module.

Solution 4. The LiDAR system according to solution 1 or 2, where the emitting module is disposed axially at an angle to the receiving module.

Solution 5. The LiDAR system according to solution 4, where the LiDAR system further includes a reflecting mirror, the probe light of the emitting module is directed to the galvanometer and the rotating mirror through the reflecting mirror, and the echo light is sequentially directed to the receiving module through the rotating mirror and the galvanometer.

Solution 6. The LiDAR system according to solution 4, where the LiDAR system further includes a reflecting mirror, the probe light of the emitting module is directed to the galvanometer and the rotating mirror through the reflecting mirror, and the echo light is sequentially directed to the receiving module through the rotating mirror, the galvanometer and the reflecting mirror.

Solution 7. The LiDAR system according to solution 6, where the reflecting mirror is provided with a reflecting region and a transmission region, the reflecting region is configured to reflect the echo light to the receiving module, and the transmission region is configured to transmit the probe light of the emitting module.

Solution 8. The LiDAR system according to solution 7, where the reflecting region is disposed surrounding the transmission region, and the transmission region is disposed correspondingly to the emitting module.

Solution 9. The LiDAR system according to solution 7 or 8, where the transmission region is a through hole.

Solution 10. The LiDAR system according to solution 7 or 8, where the reflecting mirror is provided with a partition coating, and the partition coating forms the transmission region and the reflecting region.

Solution 11. The LiDAR system according to solution 3, where the emitting module is provided with an emitting lens assembly, the receiving module is provided with a receiving lens assembly, the echo light passes through the receiving lens assembly to converge the echo light, and the receiving lens assembly is disposed axially coinciding with or parallel to the emitting lens assembly.

Solution 12. The LiDAR system according to solution 11, where the emitting lens assembly is disposed spaced apart from the receiving lens assembly.

Solution 13. The LiDAR system according to solution 12, where the emitting lens assembly is located between a light source of the emitting module and the receiving lens assembly.

Solution 14. The LiDAR system according to solution 11, where the emitting lens assembly is fixedly connected to the receiving lens assembly.

Solution 15. The LiDAR system according to any one of solutions 3, 11 to 14, where the emitting module is provided with an emitting lens assembly, the receiving module is provided with a receiving lens assembly, the receiving lens assembly is provided with a hole or a slot, a projection of the emitting lens assembly is at least partially located within a region of the hole or the slot, and the emitting lens assembly is disposed axially coinciding with or parallel to the receiving lens assembly.

Solution 16. A vehicle system, including: the LiDAR system according to any one of solutions 1 to 15.

Solution 17. The vehicle system according to solution 16, where the vehicle system is a vehicle, and the LiDAR system is mounted on a front portion of the vehicle and/or on a side of the vehicle.

1-17. (canceled)

18. A light detection and ranging (LiDAR) system, comprising:
an emitter configured to emit probe light, wherein the probe light is reflected by a target to-be-measured to form echo light;
a scanner comprising a rotating mirror and a galvanometer mirror, wherein:
both the rotating mirror and the galvanometer mirror are configured to direct the probe light and the echo light,
the rotating mirror is configured to scan in a first direction of the LiDAR system,
the galvanometer mirror is configured to scan in a second direction of the LiDAR system different from the first direction, and
the galvanometer mirror and the rotating mirror are at least partially located in a same plane; and
a receiver configured to receive the echo light.

19. The LiDAR system according to claim 18, wherein the rotating mirror and the galvanometer mirror are arranged such that a horizontal field of view formed by the probe light is greater than 120°; and/or
a vertical field of view formed by the probe light is greater than 25°.

20. The LiDAR system according to claim 18, wherein the emitter is disposed axially coinciding with or parallel to the receiver.

21. The LiDAR system according to claim 18, wherein the emitter is disposed axially at an angle to the receiver.

22. The LiDAR system according to claim 21, wherein:
the LiDAR system further comprises a reflecting mirror,
the probe light of the emitter is directed to the galvanometer mirror and the rotating mirror through the reflecting mirror, and the echo light is sequentially directed to the receiver through the rotating mirror and the galvanometer mirror.

23. The LiDAR system according to claim 21, wherein:
the LiDAR system further comprises a reflecting mirror,
the probe light of the emitter is directed to the galvanometer mirror and the rotating mirror through the reflecting mirror, and
the echo light is sequentially directed to the receiver through the rotating mirror, the galvanometer mirror, and the reflecting mirror.

24. The LiDAR system according to claim 23, wherein:
the reflecting mirror is provided with a reflecting region and a transmission region,
the reflecting region is configured to reflect the echo light to the receiver, and
the transmission region is configured to transmit the probe light of the emitter.

25. The LiDAR system according to claim 24, wherein the reflecting region is disposed surrounding the transmission region, and the transmission region is disposed correspondingly to the emitter.

26. The LiDAR system according to claim 24, wherein the transmission region is a through hole.

27. The LiDAR system according to claim 24, wherein the reflecting mirror is provided with a partition coating, and the partition coating forms the transmission region and the reflecting region.

28. The LiDAR system according to claim 20, wherein:
the emitter is provided with an emitting lens assembly,
the receiver is provided with a receiving lens assembly,
the echo light passes through the receiving lens assembly to converge the echo light, and
the receiving lens assembly is disposed axially coinciding with or parallel to the emitting lens assembly.

29. The LiDAR system according to claim 28, wherein the emitting lens assembly is disposed spaced apart from the receiving lens assembly.

30. The LiDAR system according to claim 29, wherein the emitting lens assembly is located between a light source of the emitter and the receiving lens assembly.

31. The LiDAR system according to claim 28, wherein the emitting lens assembly is fixedly connected to the receiving lens assembly.

32. The LiDAR system according to claim 20, wherein:
the emitter is provided with an emitting lens assembly,
the receiver is provided with a receiving lens assembly,
the receiving lens assembly is provided with a hole or a slot,
a projection of the emitting lens assembly is at least partially located within a region of the hole or the slot, and
the emitting lens assembly is disposed axially coinciding with or parallel to the receiving lens assembly.

33. A vehicle system, comprising a LiDAR system comprising:
an emitter configured to emit probe light, wherein the probe light is reflected by a target to-be-measured to form echo light;
a scanner comprising a rotating mirror and a galvanometer mirror, wherein:
both the rotating mirror and the galvanometer mirror are configured to direct the probe light and the echo light,
the rotating mirror is configured to scan in a first direction of the LiDAR system,
the galvanometer mirror is configured to scan in a second direction of the LiDAR system different from the first direction, and
the galvanometer mirror and the rotating mirror are at least partially located in a same plane; and
a receiver configured to receive the echo light.

34. The vehicle system according to claim 33, wherein the vehicle system is a vehicle, and the LiDAR system is mounted on a front portion of the vehicle and/or on a side of the vehicle.
